(19) United States
(12) Patent Application Publication
(10) Pub. No.: US 2016/0174038 A1
(43) Pub. Date: Jun. 16, 2016

(54) METHOD FOR INDICATING PROXIMITY, CORRESPONDING DEVICE, PROGRAM AND RECORDING MEDIUM

(71) Applicant: INGENICO GROUP, PARIS (FR)

(72) Inventors: MICKAEL MENARDAIS, SAINT MEDARD EN JALLES (FR); THIERRY MARSAUD, TALENCE (FR)

(21) Appl. No.: 14/971,328

(22) Filed: Dec. 16, 2015

(30) Foreign Application Priority Data
Dec. 16, 2014 (FR) 1462522

(51) Int. Cl. H04W 4/02; G08B 6/00; H04W 4/00; G08B 3/10

(52) U.S. Cl. CPC H04W 4/023; G08B 3/10; G08B 6/00; H04W 4/008

(57) ABSTRACT

A method and apparatus are provided for indicating proximity between a first communications device, called a detector device corresponding to an electronic card case, and a second communications device called a device to be detected. The method is implemented in a proximity indicating module attached to the detector device. The method includes at least one iteration of the following acts: receiving at least one signal sent out by the device to be detected; determining, from the received signal, at least one indication of proximity between the device to be detected and the detector device; generating at least one sound signal and/or vibration signal representing the determined indication of proximity; and sending the generated sound and/or vibratory signal.

### 1. CROSS-REFERENCE TO RELATED APPLICATIONS

This Application claims priority to and the benefit of French Patent Application No. FR1462522, filed Dec. 16, 2014, the content of which is incorporated herein by reference in its entirety.

### 2. FIELD OF THE DISCLOSURE

The disclosure pertains to the field of communications devices and more particularly to the detection of proximity or nearness between such communications devices, in order to report this proximity to a user of one of the two devices.

### 3. PRIOR ART

There are known techniques for locating objects, based for example on triangulation calculations using several signals received from several transmitter terminals. These techniques are used for example to exchange data with a device located in a given area, such as for example a user's smartphone when he enters a store.

There also exist known techniques enabling several devices to communicate with one another provided that they are sufficiently close to one another. This is the case for example with Bluetooth, RFID, NFC, and other technologies.

Thus, current techniques enable the contactless electronic payment (or validation of reduction coupons) or again contactless secured access to a building (or to public transport). The principle of these techniques relies on the presenting of a client apparatus (for example an electronic payment card, smartphone, an access badge or a public transport card) to a “target” apparatus such as an electronic payment terminal, an entry terminal for entry to a building or to public transport and on communications between the client equipment and the target equipment to carry out a transaction or authorize access.

One major drawback of these techniques lies in the difficulty for a visually impaired user to position his client apparatus close enough to the target apparatus for a communications link to be initiated without being guided by external help. Indeed, in certain situations of use, external help is not recommended for security reasons, such as for example for contactless electronic payment.

### 4. SUMMARY

A particular embodiment of the present disclosure proposes a novel solution which does not have all these drawbacks of the prior art.

A particular embodiment relates to a method for indicating proximity implemented in a proximity indicating module attached to a first communications device, called a detector device, between the detector device and a second communications device called a device to be detected, the detector device corresponding to an electronic card case and the method comprising at least one iteration of the following steps:
receiving at least one signal sent out by the device to be detected;
determining, from the received signal, at least one indication of proximity between the device to be detected and the detector device;
generating at least one sound signal and/or vibratory signal representing the determined indication of proximity;
sending the generated sound and/or vibratory signal.

Thus, an embodiment of the disclosure proposes a novel and inventive solution to the indication of proximity between two devices, based firstly on determining an indication of proximity between the two devices on the basis of a signal received, by the detector device, coming from the device to be detected and secondly on generating a “sensory” signal (sound, vibration or both) representing this proximity.

Indeed, the method for indicating proximity according to an embodiment of the disclosure implemented in a proximity indication module attached to a detector device (for example integrated into this device or comprising this device) makes it possible not only to determine the proximity between two devices but also to send out a sensory signal depending on and representing the proximity determined. Thus, the sensory signal is not limited to a “binary” sensory signal activated through a certain piece of proximity information but varies according to the determined value of proximity. For example, the intensity, frequency or again the very shape of the sensory signal generated varies as a function of the degree of proximity between the two devices.

In addition, the “sensory” signal generated and sent by the proximity indicating module according to the method of an embodiment of the disclosure is designed to be picked up or sensed by a visually impaired user and is therefore distinguished from a visual signal. For example, when a visually impaired user seeks to bring a detector device, provided with a proximity indicating module implementing the method according to an embodiment of the disclosure, closer to a device to be detected, without seeing this device to be detected, the proximity indication module vibrates (at varying degrees of intensity depending on proximity) or emits a sound (with varying degrees of loudness or with different sounds according to proximity) as and when the device to be detected gets closer.

One particularly valuable application of an embodiment of the disclosure is that of assisted NFC payment for a visually impaired user. Thus, according to one embodiment, the detector device corresponds to a client apparatus, for example a smartphone or an electronic card case or pouch (for example an electronic payment card holder or an access card holder) implementing the method of an embodiment of the disclosure and furthermore comprising a NFC type communications interface to carry out NFC payments with an electronic payment terminal (constituting the device to be detected). A visually impaired user carrying a smartphone and wishing to make an NFC payment with an electronic payment terminal can therefore benefit from an indication of proximity between his smartphone and the electronic payment terminal via a sound and/or vibratory signal sent out by these smartphones depending on the distance from the electronic payment terminal. For example, his smartphone will vibrate with increasing intensity as he approaches the electronic payment terminal, thus enabling the visually impaired user to know that he is pointing his smartphone in the right direction.

In one variant of this embodiment, the card holder or card case for an electronic payment card is equipped with a proximity indication module so as to be made “smart” and be able to help a visually impaired user as he brings his electronic payment card closer to the electronic payment terminal during an NFC payment.

An embodiment of the disclosure can also apply to the validation of reduction or loyalty coupons on a same principle as in an NFC payment.

In another application of an embodiment of the disclosure, a visually impaired user is helped to obtain access to a building or to public transport. This would be obtained by near-field communication between his smartphone or an access card carried in a smart case as described here above and an entry post of a building or an underground platform or tramway platform or again a point of entry into a bus.

Yet another application that can be envisaged, not dedicated to visually impaired users, relates to secured access to a room in a building, consisting solely of the detection of the right access card, this access besides being in no way visible so as to preserve its security. Thus, a building having several “clean rooms” dedicated to different operators or groups of persons can have secured access to each of these rooms only through the detection of the authorized access card at each room door, without any visual indication stating which operator each room is dedicated to.

For example, when the received signal corresponds to a radio signal, the step for determining an indication of proximity comprises a step for computing a distance between the devices, taking account of a measurement of a characteristic of the received radio signal and at least one piece of information on correspondence between a value of the characteristic of the signal and a distance.

Thus, this embodiment particularly enables the use of signals sent out by the device to be detected, not specifically dedicated to an embodiment of the disclosure (for example Bluetooth signals sent out by a communication terminals for the purpose of pairing with another communications terminal) by measuring a characteristic of it in order to determine a distance between the two devices.

For example, the intensity or the power of a received signal coming from the device to be detected is measured and makes it possible, by application of a table of correspondence between a signal power and a distance, to determine an indication of the distance between the two devices. This table of correspondence indicates for example that, at a distance of one meter between the two devices, the level of the signal must correspond to a first value whereas at a distance of 50 cm, the level of the signal must correspond to a second value and so on and so forth. In this way, depending on the level of the signal measured, it is possible to evaluate the distance between the two devices.

An indication of proximity can therefore correspond to an evaluated distance between the two devices or to an interval comprising a minimum distance evaluated and a maximum distance evaluated between the two devices.

According to one particular aspect, the radio signal corresponds to a Bluetooth low-energy type signal and the measured characteristic corresponds to the level of the signal received.

Thus, this embodiment enables the use of a Bluetooth Low Energy type radio signal or Bluetooth Smart signal emitted by the device to be detected and the measurement of its level so as to then determine the distance between the two devices.

Indeed, most electronic payment terminals already possess (or will possess) this Bluetooth Low Energy function and therefore send out signals of this type, the power of which can be measured to determine the proximity of the sender device relative to the detector device.

Similarly, most smartphone type mobile communications terminals also possess this Blue Tooth Low Energy function.

According to one particular characteristic, the step for generating the sound signal and/or vibratory signal comprises a step for parameterizing at least one characteristic of the sound signal and/or vibratory signal generated as a function of the determined indication of proximity.

Thus, this embodiment makes it possible to vary a characteristic of the sound and/or vibratory signal sent out by the proximity indication module as a function of the very value of the determined indication of proximity.

For example, if it is a sound signal, its level can increase as the distance between the two devices diminishes or different sound patterns can be used depending on distance (for example from the lowest-pitched sounds to the highest-pitched sounds as the distance diminishes).

If it is a vibratory signal, the level and/or frequency of the vibrations can increase as the distance between the two devices diminishes.

Finally, if it is a signal combining sound and vibrations, every combination can be considered (modification of sound only with constant vibrations, modification of vibrations only with constant sound signal, modification of both signals combined).

According to one particular embodiment, the number of iterations of the steps for receiving, determining, generating and sending depends on at least one predetermined criterion representing the indication of proximity determined at the previous iteration.

Thus, this embodiment limits the number of iterations of the different steps of the method according to the indication of proximity determined at the previous iteration.

Finally, when the distance evaluated between the two devices is considered to be sufficient to carry out the desired application (for example so that the two devices can communicate according to predefined criteria), then the user must be made to understand that both devices are accurately positioned to implement the desired application.

For example, when the distance evaluated at the previous iteration is smaller than a certain predetermined threshold, then it is necessary either to continue sending out the same sound signal and/or vibratory signal or stop sending this signal so that the user knows that he can stop moving his device.

An embodiment of the disclosure also pertains to a proximity indicating module attached to a first communications device, called a detector device, between the detector device and a second communications device, called a device to be detected, the detector device corresponding to an electronic card case and the proximity indication module comprising the following means:
means for receiving at least one signal sent by the device to be detected;
means for determining, from the received signal, at least one indication of proximity between the device to be detected and the detector device;
means for generating at least one sound signal and/or vibratory signal representing the determined indication of proximity;
means for sending out the generated sound signal and/or vibratory signal.

For example, such a module is integrated into a communications terminal such as a smartphone or a tablet or else an electronic payment card case.

An embodiment of the disclosure also pertains to a computer program downloadable from a communications network and/or stored on a computer-readable medium and/or executable by a microprocessor for the implementation of a method as described here above, when this program is executed by a processor.

Finally, an embodiment of the disclosure pertains to a computer-readable recording medium on which there is recorded a computer program comprising a set of instructions executable by a computer or a processor to implement the method as described here above when this program is executed by a processor.

### 5. FIGURES

Other features and advantages shall appear more clearly from the following description of a preferred embodiment given by way of a simple, illustratory and non-exhaustive example and from the appended figures of which:

FIG. 1 presents the main steps of the method for indicating proximity according to one particular embodiment of the disclosure;

FIG. 2 presents a diagram of sequences according to one particular embodiment of the disclosure;

FIGS. 3a and 3b present two examples of a system that can implement the method for indicating proximity, according to two particular embodiments;

FIGS. 4 and 5 illustrate two examples of simplified architecture of a proximity indicating module according to one particular embodiment of the disclosure.

### 6. DESCRIPTION

### 6.1. General Principle

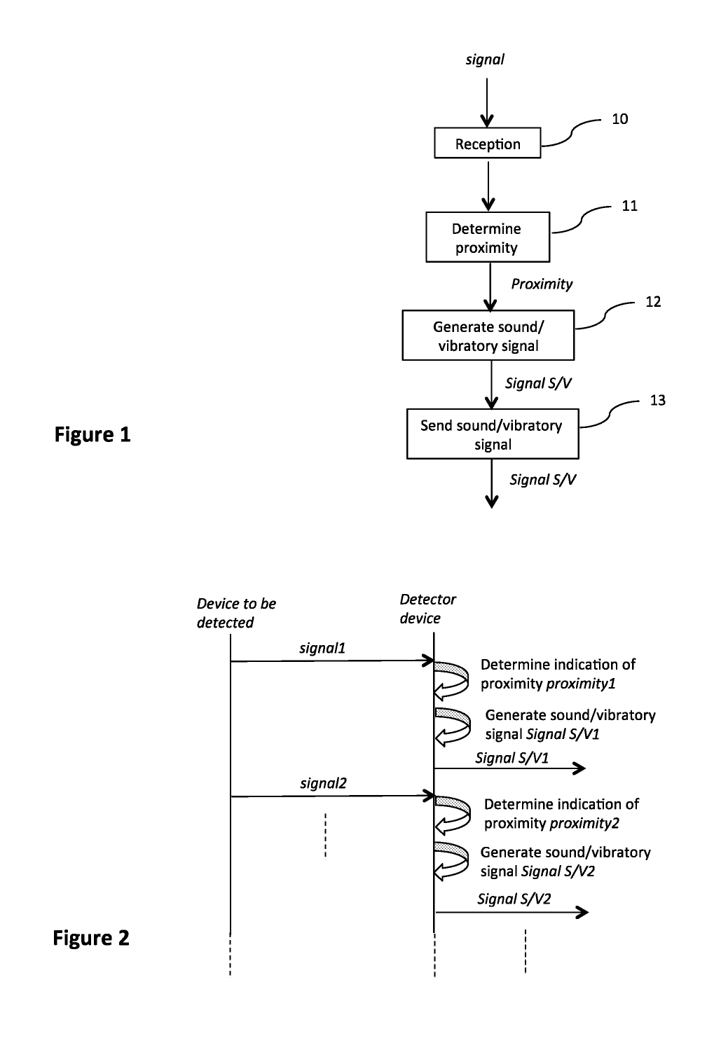

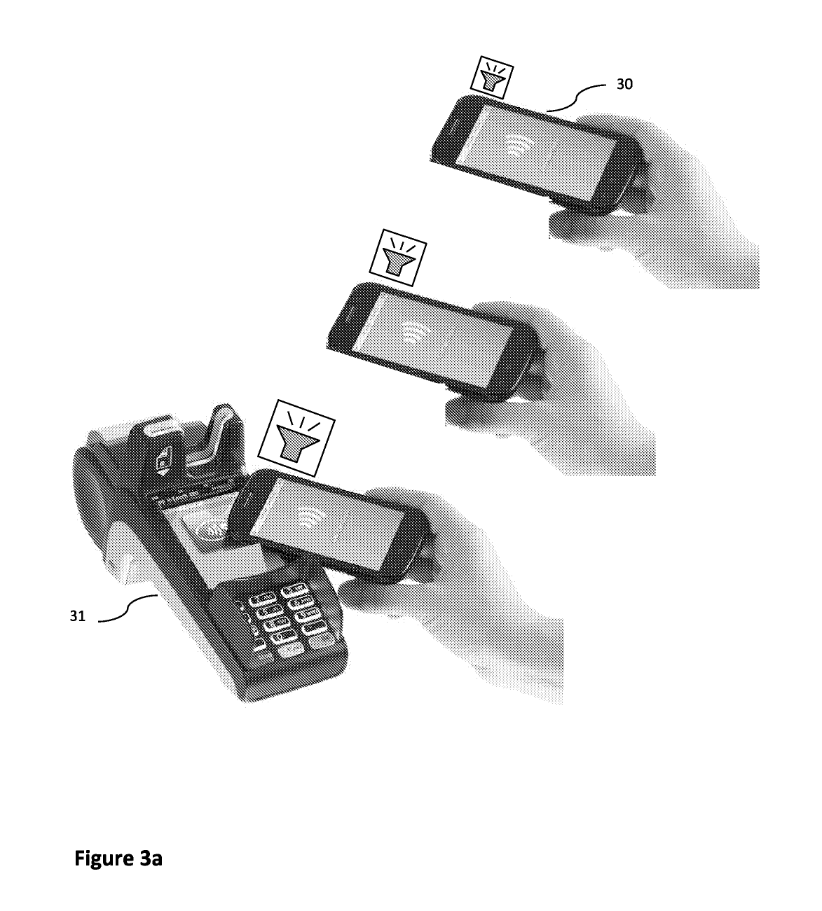

The general principle of an embodiment of the disclosure, described with reference to FIGS. 1 and 2, consists in determining an indication of proximity between two devices on the basis of a signal received by a first device, coming from a second device and sending a sound signal and/or vibratory signal representing this proximity to the user of the first device.

To this end, an embodiment of the disclosure is implemented in a specific module, here below called a proximity indication module, attached to the first device, i.e. for example integrated into this first device or carrying this first device.

Besides, since the sound and/or vibratory signal represents proximity, it depends on the indication of proximity, for example by varying certain of its own characteristics.

For example, a visually impaired user seeking to bring a device in his possession closer to another remote device for a particular application requiring communications between the two devices, is informed of the distance remaining between his device and the second device by a sound signal and/or vibratory signal sent out by his own device.

As illustrated in FIG. 1, a first step 10 is therefore implemented within the proximity indication module for receiving a signal received from a remote device, hereby denoted as a device to be detected. This signal sent by the device to be detected is not specific to an embodiment of the disclosure but can be sent out in the context of any other application.

For example, such a signal corresponds to a Bluetooth Low Energy type signal that can be received at up to 50 meters. It is indeed increasingly frequent for a communications terminal to present such Bluetooth communications interface, especially for locating applications within. The principle of this type of locating application or micro-locating application relies on the layout of several beacons sending out Bluetooth Low Energy signals capable of being received by a smartphone (or a tablet) equipped with an application to listen to these beacons. When the smartphone picks up the Bluetooth signals sent out by the beacon, it then recognizes the beacon from which the signal is coming and can estimate the distance at which this beacon is situated in analyzing the power of the signal for example.

This function can be used in the method, according to this embodiment, to determine the proximity between the first detector device (for example a smartphone capable of listening to a Bluetooth Low Energy signal) and the second device to be detected (for example an electronic payment terminal emitting Bluetooth Low Energy signals of this kind).

Thus, from this signal received at the step 10, a step 11 to determine an indication of proximity is carried out in the proximity indicating module in order to determine the distance or the range of distances at which the two devices are situated from each other.

For example, the level of the received signal is enough to determine the distance or an order of magnitude of this distance between the two devices. In this case, the step for determining also uses a correspondence table to evaluate a distance on the basis of a signal level. To this end, a measurement of the strength of the received signal of the “Received Signal Strength Indication” (RSSI) type can be implemented.

According to another example, the received signal carries a piece of locating information for locating the device to be detected and the distance between the two devices can be computed by the proximity indicating module, the location of the detection device being known. This type of computation is well known and is not described in detail herein.

Once the indication of proximity has been determined at the step 11, a step 12 for generating a sound and/or vibratory signal (denoted as Signal S/V here below) representing the indication of proximity is implemented. Thus, one or more characteristics of the S/V signal are parameterizable to “reflect” the degree of proximity determined for the attention of the user during the step 13 for sending this generated Signal S/V. This step for generating an S/V signal is described in greater detail here below with reference to different embodiments of the disclosure.

FIG. 2 for its part illustrates the progress of the steps described here above as and when the detector device moves towards the device to be detected.

Indeed, for the sound and/or vibratory signal S/V to be capable of reflecting the degree of proximity between the two devices, when one of the devices is mobile, then a new indication of proximity has to be determined in order to generate or emit a new sound signal S/V representing the current distance between the two devices.

To this end, the steps 10 to 13 described here above are reiterated, for example periodically, or upon reception of a new signal coming from the device to be detected.

Thus, as illustrated in FIG. 2, a first signal Signal S/V1 is generated and sent, following the reception of a signal signal1 coming from the device to be detected and the determination of a first indication of proximity proximity1. Then, upon reception of a signal signal2 coming from the device to be detected, a second indication of proximity proximity2 is determined so as to generate and send out a second signal Signal S/V2.

Whatever the way in which the iterations are made (periodically or at reception of a new signal), the number of iterations of the steps of the method can be limited by a minimum distance beyond which it is no longer necessary to modify the sound signal and/or vibratory signal sent out or even to send it.

Indeed, it is considered that when the two devices are close enough to carry out a desired application (for example contactless payment), it is no longer necessary to inform the user of the degree of proximity. It can even be preferable to stop sending the sound and/or vibratory signal so that the user will know that he can stop moving his detector device and leave it positioned at the same place to carry out the desired application.

It must be noted that the disclosure according to its different embodiments is based on the reception of signals sent out by a device capable of implementing any type of radio, Wi-Fi or non-standardized protocols, responding to the same set of problems and issues for determining proximity on the basis of a received signal.

### 6.2. Description of a First Embodiment

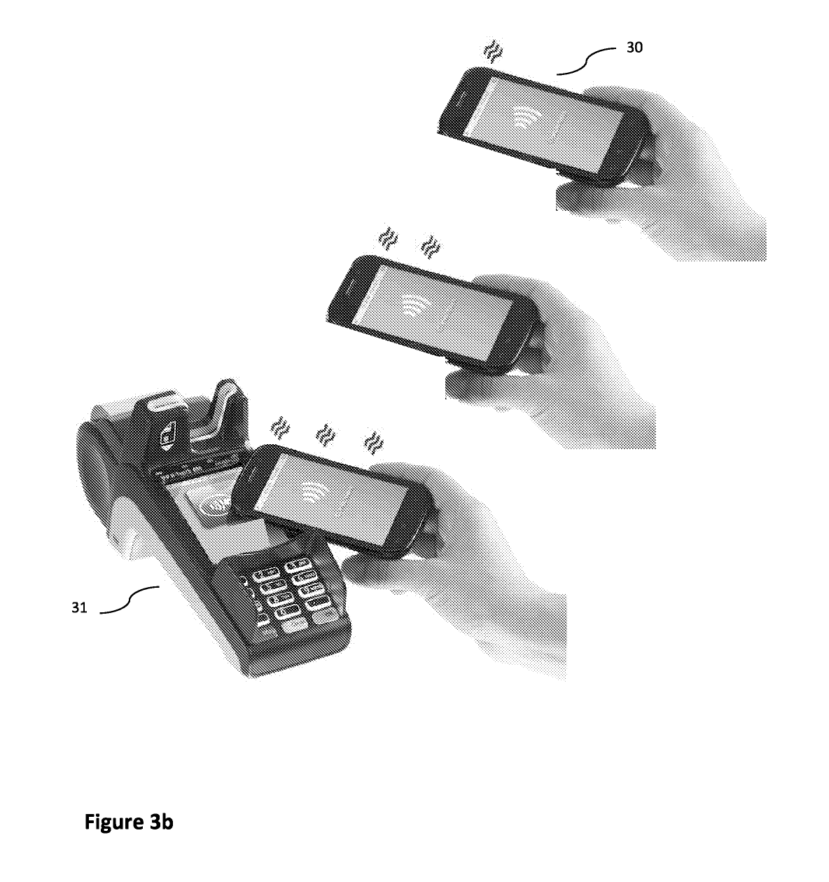

Referring now to FIGS. 3a and 3b, we shall now describe two variants of a first particular embodiment of the disclosure in which the detector device 30 corresponds to a client's smartphone and the device to be detected 31 corresponds to an electronic payment terminal, the two devices implementing NFC type near field communications interface for carrying out a contactless payment application.

This type of contactless payment using NFC technology is being implemented with increasing frequency because it allows the user not to have to enter any secret code to validate a transaction, thus giving rise to considerable gain in time.

Besides, when this contactless payment technique implements a user's mobile terminal (for example a smartphone), it is based on a “card emulation” mode or “passive” mode in this mobile terminal of the user which then behaves like a contactless smartcard. Should the mobile telephone be a compatible mobile telephone, the operator's SIM card can be used as a secured element in storing the encrypted information.

The uses of this NFC technique are numerous:
payment on a contactless electronic payment terminal;
payment for parking at a post accepting contactless payments;
purchase and contactless validation of a transportation ticket or a ticket for entry to a show;
management of reduction coupons in a store, management of loyalty points at a merchant's premises (known as “couponing”);
access and starting of a car share system;
control of access to premises with reserved access (meeting rooms, company rooms, classrooms, etc.);
access to home automation functions in a building.

The NFC transmission range is very short, between 5 to 20 cm between the objects involved, i.e. in the example illustrated in FIGS. 3s and 3b, between the mobile terminal 30 and the electronic payment terminal 31.

FIGS. 3a and 3b therefore each present three successive steps in which the mobile terminal 30 approaches the electronic payment terminal 31.

Indeed, it is necessary to make the mobile terminal 30 come relatively close to the electronic payment terminal 31 so that the payment application can be implemented, thus giving rise to difficulties of use for a visually impaired user.

Indeed, at present, a visually impaired user must be assisted by someone in order to bring his mobile terminal sufficiently and precisely close to the electronic payment terminal so that the payment application can be activated. Now, such a payment application normally requires all the security precautions in order to prevent a malicious person from taking advantage of the handicap of a visually impaired user. These security requirements are therefore incompatible with assistance by a third party in payment involving a visually impaired user.

The method according to this embodiment of the disclosure thus frees a visually impaired user of the need for human assistance of this kind by enabling him to be in real time as and when his mobile terminal moves towards the electronic payment terminal, about the remaining distance between his mobile terminal and the electronic payment terminal.

To this end, the user's mobile terminal 30 is provided, via a proximity indicating module according to an embodiment of the disclosure, for example integrated into the mobile terminal 30, with a receiver for receiving signals sent out by the electronic payment terminal 31. For example, these sent signals are Bluetooth Low Energy type signals.

In addition, the proximity indicating module presents is configured for determining proximity between the two devices and for generating a signal according to this proximity.

According to the first variant illustrated in FIG. 3a, the signal generated and sent by the mobile terminal 30, via the proximity indicating module, is a sound signal illustrated by a “loudspeaker” type icon in FIG. 3a.

As already described here above, the sound signal generated and sent represents the determined indication of proximity. For example, the level of the sound signal increases with proximity, i.e. the signal is increasingly louder as and when the mobile terminal 30 approaches the electronic payment terminal 31. This is especially illustrated in FIG. 3a by an increasing size of the loudspeaker icon.

Thus, for a visually impaired user bringing his mobile terminal closer to the electronic payment terminal, the increase of the sound signal sent out by his mobile terminal gives him an indication of proximity between his mobile terminal and the “target” electronic payment terminal, so that he is certain that he can continue to point his mobile terminal towards the electronic payment terminal in the same direction while knowing that he is not yet close enough to this electronic payment terminal to carry out the contactless payment application.

Indeed, as already described here above, the method of an embodiment of the disclosure makes it possible, according to this first variant of the first embodiment, not only to modify the level of the sound signal according to the indication of proximity as and when the iterations of the method are carried out, but also to stop the sending of the sound signal according to the indication of proximity determined at the previous iteration. Thus, it is planned to no longer generate the sound signal when a distance sufficient to implement the NFC contactless payment is reached, so that the user immobilizes his terminal in the position in which he is situated.

Thus, this first variant of the first embodiment of the disclosure enables a user to direct his terminal towards the electronic payment terminal in listening to the sound signals sent out by his own mobile terminal and being sure that his mobile terminal is truly positioned when it no longer generates any sound signal.

On the contrary, the user can modify the direction of his mobile terminal, if the level of the sound signal emitted by this mobile terminal diminishes, informing him that the distance between his mobile terminal and the target electronic payment terminal is increasing.

It can also be envisaged that the very sound of the generated sound signal generated and emitted will be different depending on the determined distance, for example in planning for an increasingly high-pitched sound or an increasingly low-pitched sound.

The second variant illustrated in FIG. 3b is distinguished from the first variant only by the form of the signal generated and sent by the detector device, in this case the user's mobile terminal 30. Thus, according to this second variant, the signal is vibratory and the vibrations increase, for example in intensity and/or in frequency, as and when the mobile terminal 30 approaches the electronic payment terminal 31. This is represented in FIG. 3a by the “vibrations” type icon which is reproduced two or three times, the closer the mobile terminal 30 comes to the electronic payment terminal 31.

Thus, the user carrying the mobile terminal 30 feels increasingly strong vibrations or increasingly frequent or fast vibrations if he truly points his mobile terminal 30 towards the electronic payment terminal 31. On the contrary, if the is not pointing his mobile terminal in the right direction, the vibrations diminish (in intensity and/or in frequency), and even stop, thus informing the user that he is not bringing his mobile terminal 30 closer to the electronic payment terminal 31.

As in the first variant, when a sufficient predetermined distance is attained between the mobile terminal 30 and the electronic payment terminal 31 to implement an NFC contactless payment, the vibrating signal is no longer sent and the user knows that he can maintain the position of his mobile terminal 30 until the end of the payment.

The choice of the type of signal, whether sound and/or vibrating, can depend on several criteria such as for example the type of device integrating the proximity indicating module according to an embodiment of the disclosure or user preferences, or again a criterion of security related to the “target” application (a contactless payment for example).

Thus, if the proximity indicating module is integrated into a device not offering the possibility of generating and sending a vibratory signal, it is the sound signal that is sent and vice versa.

If the device integrating the proximity indicating module according to an embodiment of the disclosure enables the generation of both types of signals (sound or vibration), the choice can be made according to the preferences of the user of the device who can be more sensitive to either of the signals for example.

Finally, certain security constraints can lead to the choice of either type of signal. For example, when an embodiment of the disclosure is implemented in the context of a contactless payment, it is preferable for the emitted signal to be more discreet than a sound signal while at the same time being easily recognized by the user. In this case, a vibratory signal responds both to the security requirements and ergonomic requirements for the user.

Besides, as already indicated here above, the two types of signals, namely a sound signal and a vibratory signal, can be sent simultaneously for better efficiency.

### 6.3. Description of a Second Embodiment

This second embodiment, which is not shown, provides that the proximity indicating module is integrated into a card case or a card carrier enabling an electronic payment card to be carried in order to implement an NFC type contactless payment as described with reference to the first embodiment.

Thus, according to this second embodiment, it is the bankcard case carrying the user's communications device, namely his contactless payment card, that implements an embodiment of the disclosure, i.e. it detects a signal coming from a device to be detected (in this case an electronic payment terminal), determines a indication of proximity between the case and the electronic payment terminal, and then generates and sends a sound and/or a vibrating signal to inform the bearer of the case as to whether he is approaching or not approaching an electronic payment terminal.

This second embodiment therefore offers the same advantages as those described with reference to the first embodiment without requiring any modification of the payment device, namely the user's payment card. Indeed, it is the case/card holder that integrates the proximity indicating module according to an embodiment of the disclosure and enables the invention to be applied.

This second embodiment also relates to any type of application requiring an electronic card to be brought closer to its target such as a card for access to a building or a room of a building, a transportation card, etc., enabling an embodiment of the disclosure to be implemented through a case that can carry the electronic card without modification of the card and integrating the proximity indicating module.

### 6.4. Description of a Third Embodiment

In the first two embodiments described here above, the proximity indicating module is integrated into a client equipment (a mobile terminal or an electronic payment card case) with a view to its interaction with a target apparatus (an electronic payment terminal).

In this third embodiment, which is not shown, the proximity indicating module is integrated into a target apparatus, for example an electronic payment terminal, with a view to its interaction with a client apparatus.

For example, in the context of an NFC type contactless payment application, it is the electronic payment terminal that implements an embodiment of the disclosure so as to facilitate the approach by a visually impaired user's mobile terminal.

Thus, it is the electronic payment terminal that detects the signal sent out by the user's mobile terminal (for example a smartphone equipped with Bluetooth Low Energy technology) to determine an indication of proximity between itself and the user's mobile terminal. From this indication of proximity, it is also the electronic payment terminal that generates or sends a signal representing this proximity.

In this third embodiment, it is understood that a sound signal is more suitable than a vibratory signal because it is the electronic payment terminal that sends it out and no longer the user's mobile terminal as in the first and second embodiments.

In addition, it is possible, according to one variant of this third embodiment, for the method for indicating proximity to be capable of being activated and deactivated, for example by the merchant in possession of the electronic payment terminal. Thus, when a visually impaired user asks for implementation of the proximity indication service, the merchant activates the proximity indicating module integrated into the electronic payment terminal in order to help the user with his contactless payment.

### 6.5. Simplified Architecture of a Proximity Indication Module

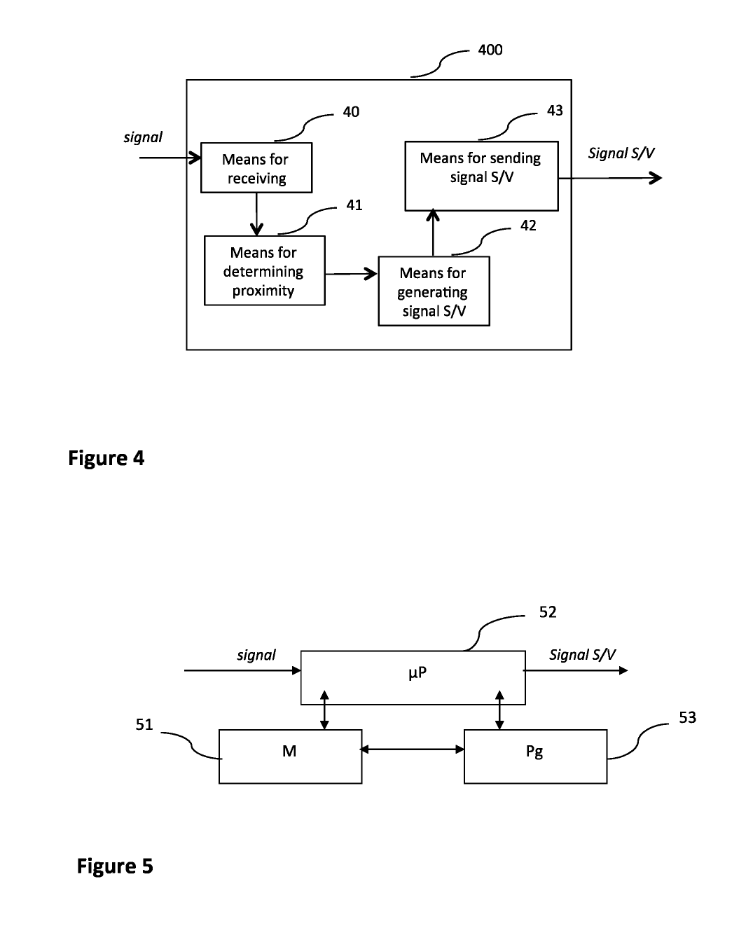

Referring to FIGS. 4 and 5, we describe an example of a proximity indication module comprising means for executing the method described here above.

Thus, as illustrated in FIG. 4, a module 400 of this kind integrated for example into a smartphone or an electronic card case comprises the following means (for example in the form of one or more sub-modules):
receiver 40 for receiving at least one signal sent out by the device to be detected;
sub-module 41 for determining, from the received signal, at least one indication of proximity between the device to be detected and the detector device;
generator 42 for generating at least one sound signal and/or vibratory signal representing the determined indication of proximity;
emitter 43 for sending out the generated sound signal and/or vibratory signal.

This module 400 is now described with reference to FIG. 5.

For example, the module comprises a memory 51 constituted by a buffer memory, a processing until 52, equipped for example with a microprocessor, and driven by the computer program 53 implementing a proximity indication method according to the different embodiments described here above.

At initialization, the code instructions of the computer program 53 are for example loaded into a memory and then executed by the processor of the processing unit 52. The processing unit 52 inputs for example a signal sent out by a device to be detected, for example an electronic payment terminal. The microprocessor of the processing unit 52 implements the steps of the method for indicating proximity according to the instructions of the computer program 53 to generate and send out a sound signal and/or vibratory signal denoted as Signal S/V.

Although the present disclosure has been described with reference to one or more examples, workers skilled in the art will recognize that changes may be made in form and detail without departing from the scope of the disclosure and/or the appended claims.

1. A method for indicating proximity between a first communications device and second communications device, the method being implemented in a proximity indicating module attached to the first communications device, wherein said first communications device corresponds to an electronic card case and the method comprises at least one iteration of the following acts:
receiving by the proximity indicating module of the electronic card case, at least one signal sent out by said device to be detected;
determining from the received signal, at least one indication of proximity between said device to be detected and said electronic card case;
generating at least one sound signal and/or vibratory signal representing said determined indication of proximity; and
sending the generated sound and/or vibratory signal from the electronic card case.

2. The method for indicating proximity according to claim 1, wherein, said received signal corresponds to a radio signal, and said act of determining an indication of proximity comprises computing a distance between said electronic card case and said device to be detected, taking account of a measurement of a characteristic of said received radio signal and at least one piece of information on correspondence between a value of said characteristic of said signal and a distance.

3. The for indicating proximity according to claim 2, wherein said radio signal corresponds to a Bluetooth low-energy type signal and the measured characteristic corresponds to the level of the signal received.

4. The method for indicating proximity according to claim 1, wherein said act of generating said sound signal and/or vibratory signal comprises parameterizing at least one characteristic of said sound signal and/or vibratory signal generated as a function of said determined indication of proximity.

5. The method for indicating proximity according to claim 1, wherein the number of iterations of the acts of receiving, determining, generating and sending depends on at least one predetermined criterion representing said indication of proximity determined at the previous iteration.

6. A proximity indicating module attached to a first communications device, first communications device corresponding to an electronic card case and said proximity indication module comprising:
means for receiving at least one signal sent by a second communications device, called a device to be detected;
means for determining, from said received signal, at least one indication of proximity between said device to be detected and said electronic card case;
means for generating at least one sound signal and/or vibratory signal representing said determined indication of proximity; and
means for sending out said generated sound signal and/or vibratory signal from said electronic card case.

7. (canceled)

8. A non-transitory computer-readable recording medium on which there is recorded a computer program comprising a set of instructions executable by a computer or a processor to implement a method for indicating proximity between a first communications device and a second communications device, called a device to be detected, when this program is executed by a processor of a proximity indicating module attached to the first communications device, wherein said first communications device device corresponds to an electronic card case and the method comprises:
at least one iteration of the following acts:
receiving, by the proximity indicating module of the electronic card case, at least one signal sent out by said device to be detected;
determining, from the received signal, at least one indication of proximity between said device to be detected and said electronic card case;
generating at least one sound signal and/or vibratory signal representing said determined indication of proximity; and
sending the generated sound and/or vibratory signal from the electronic card ease.
